(19) United States
(12) Patent Application Publication
(10) Pub. No.: US 2014/0256183 A1
(43) Pub. Date: Sep. 11, 2014

(54) POWER CONVERTER PLUG MOUNTABLE MOBILE ELECTRONIC DEVICE HOLDER

(71) Applicant: CHEN-SOURCE INC., Taoyuan County (TW)

(72) Inventor: Cheng-Yun WU, New Taipei City (TW)

(73) Assignee: CHEN-SOURCE INC., Taoyuan County (TW)

(21) Appl. No.: 13/790,823

(22) Filed: Mar. 8, 2013

(51) Int. Cl. H01R 13/46

(52) U.S. Cl. CPC H01R 13/46
USPC 439/625

(57) ABSTRACT

A power converter plug mountable mobile electronic device holder includes a hollow holder base that defines a mating chamber for receiving a power converter plug of a power converter cable to be connected to an electric wall outlet in a wall, a top bearing surface at a top side thereof and adapted to bear a mobile electronic device being electrically charged by the power converter cable, and stop members suspending above the elevation of the bearing surface and adapted to support the mobile electronic device on the bearing surface. Thus, subject to the use of the power converter plug mountable mobile electronic device holder to hold a mobile electronic device during charging, the mobile electronic device is protected against contamination, water stains, insect biting, or vibrating or falling damage.

### BACKGROUND OF THE INVENTION

1. Field of the Invention

The present invention relates to mobile electronic device holder technology and more particularly, to a power converter plug mountable mobile electronic device holder for mounting on a power converter plug of a power converter cable to hold a mobile electronic device being electrically charged by the power converter cable with city power supply from an electric wall outlet.

2. Description of the Related Art

With fast development of electronic and multimedia information technologies, smart phones, tablet computers, PDAs, multimedia players, digital cameras, electronic dictionaries and many other advanced mobile electronic devices have been created and have appeared on the market. The internal component parts of these advanced mobile electronic devices commonly use a DC power supply. Because the power distribution system of a power supply company simply provides AC power supply to end-users, city power supply cannot be directly used to charge a DC operated mobile electronic device. In this case, power converter means, for example, a power convertible cable should be used to convert city power supply into the desired DC power supply.

Further, we may have different supply voltages in the range of 100˜240V in different countries. Further, electric wall outlets may be provided in a concrete wall, wooden wall or metal wall panel of a building for allowing people to get city power supply. People may use a power converter cable to connect a mobile electronic device to an electric wall outlet, enabling the mobile electronic device to be electrically charged. However, if the mobile electronic device is placed on the floor when it is being charged with city power supply by a power converter cable, it may get stained by water, oil, dust or color, or get bitten by insects. If the mobile electronic device is suspending in the air when it is being charged with city power supply by a power converter cable that is connected to an electric wall outlet high above the floor, it may swing in the air or fall to the floor, causing damage.

Therefore, it is desirable to provide a mobile electronic device holder that can hold a mobile electronic device steadily in place and protect it against contamination and damage when the mobile electronic device is being charged with city power supply by a power converter cable.

### SUMMARY OF THE INVENTION

The present invention has been accomplished under the circumstances in view. It is the main object of the present invention to provide a power converter plug mountable mobile electronic device holder, which can be mounted on a power converter plug of a power converter cable to hold a mobile electronic device being electrically charged by the power converter cable with city power supply from an electric wall outlet.

To achieve this and other objects of the present invention, a power converter plug mountable mobile electronic device holder comprises a hollow holder base. The hollow holder base defines a mating chamber for receiving a power converter plug of a power converter cable to be connected to an electric wall outlet in a wall, a top bearing surface at a top side thereof and adapted to bear a mobile electronic device being electrically charged by the power converter cable, and stop members suspending above the elevation of the bearing surface and adapted to support the mobile electronic device steadily on the bearing surface, avoiding contamination, water stains, insect biting, or swinging or falling damage of the mobile electronic device.

Further, a box-like magnet holder shell provided with magnets can be inserted into the mating chamber of the hollow holder base after removal of the power converter cable and secured with the hollow holder base to a metal wall by the magnets by means of magnetic attraction to hold a mobile electronic device on the top bearing surface of the hollow holder base, letting the mobile electronic device be stopped between the stop members and the metal wall.

### BRIEF DESCRIPTION OF THE DRAWINGS

FIG. 1 is an elevational view of a power converter plug mountable mobile electronic device holder in accordance with a first embodiment of the present invention.

FIG. 2 is a schematic drawing illustrating the relationship between the power converter plug mountable mobile electronic device holder in accordance with a first embodiment of the present invention and a power converter plug of a mating power converter cable.

FIG. 3 illustrates an application example of the power converter plug mountable mobile electronic device holder in accordance with the first embodiment of the present invention.

FIG. 4 is an elevational view of a power converter plug mountable mobile electronic device holder in accordance with a second embodiment of the present invention.

FIG. 5 is an elevational view of a power converter plug mountable mobile electronic device holder in accordance with a third embodiment of the present invention.

FIG. 6 is an elevational view of a power converter plug mountable mobile electronic device holder in accordance with a fourth embodiment of the present invention.

FIG. 7 is an exploded view of a power converter plug mountable mobile electronic device holder in accordance with a fifth embodiment of the present invention.

FIG. 8 illustrates another application example of the power converter plug mountable mobile electronic device holder in accordance with the fifth embodiment of the present invention.

### DETAILED DESCRIPTION OF THE PREFERRED EMBODIMENT

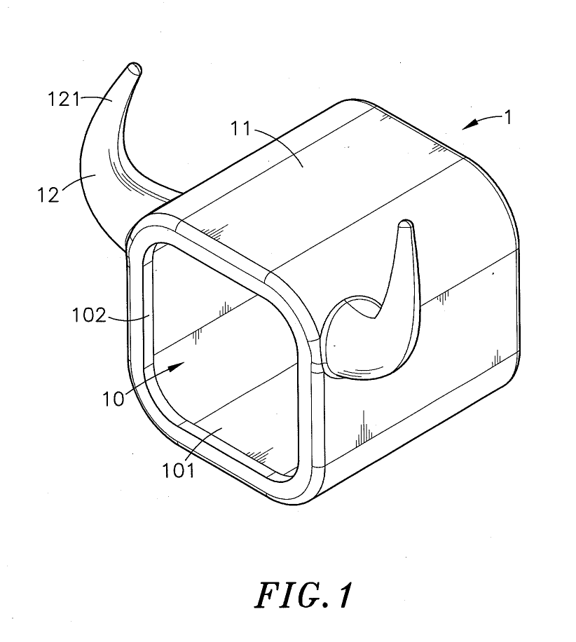

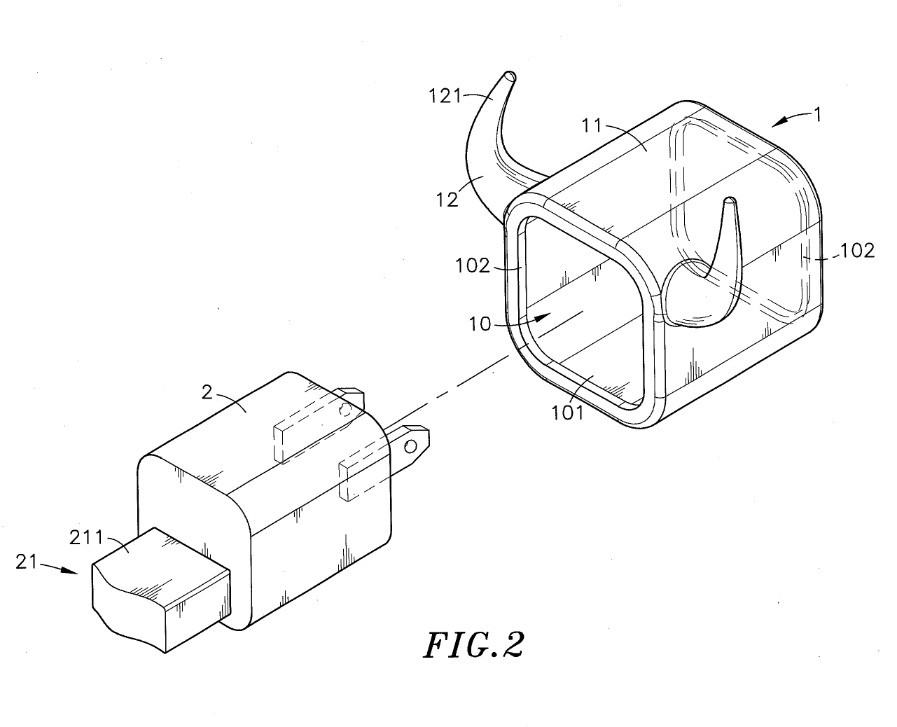

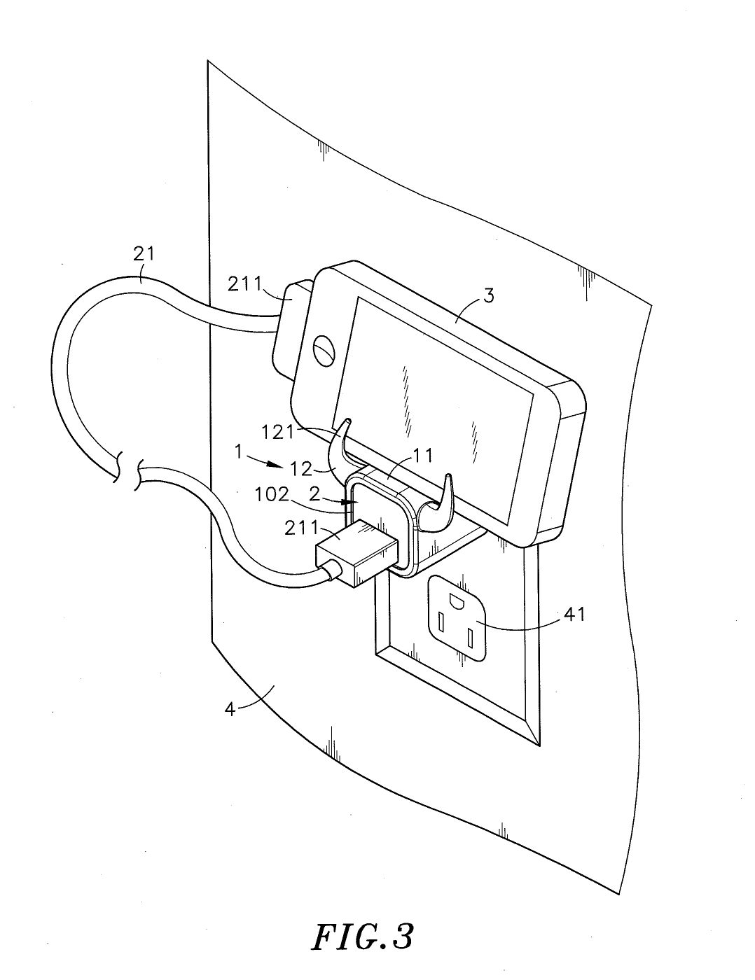

Referring to FIGS. 1-3, a power converter plug mountable mobile electronic device holder in accordance with a first embodiment of the present invention is shown. The power converter plug mountable mobile electronic device holder comprises a hollow holder base 1. The hollow holder base 1 defines a mating chamber 10, two openings 101 respectively disposed at opposing front and rear sides thereof in communication between the mating chamber 10 and the outside open space, a stop flange 102 protruded from the inside wall thereof within each of the two openings 101, a planar bearing surface 11 located at a top side thereof, and at least one, for example, two stop members 12 respectively outwardly extended from two opposite lateral sides thereof in a symmetrical manner and respectively terminating in an upwardly extended and gradually reduced retaining tip 121 above the elevation of the planar bearing surface 11.

The power converter plug mountable mobile electronic device holder is mountable on a power converter plug 2 at one end of a power converter cable 21, which comprises a connector 211 located at an opposite end thereof and connectable to a power jack (not shown) of a mobile electronic device 3 (cell phone, smart phone, PDA, mobile multimedia player, etc.). The power converter plug 2 is connectable to an electric wall outlet 41 in a wall 4 for receiving city power supply and converting city power supply into a predetermined DC power required for the mobile electronic device 3. When mounting the power converter plug mountable mobile electronic device holder on the power converter plug 2, directly insert the power converter plug 2 through one opening 101 of the hollow holder base 1 into the mating chamber 10 to have the power converter plug 2 be stopped between the two stop flanges 102 of the hollow holder base 1.

During application of the power converter plug mountable mobile electronic device holder, the hollow holder base 1 of the power converter plug mountable mobile electronic device holder is mounted on the power converter plug 2 of the power converter cable 21 by inserting the power converter plug 2 through one opening 101 of the hollow holder base 1 into the mating chamber 10 to have the power converter plug 2 be stopped between the two stop flanges 102 of the hollow holder base 1, and then insert the protruding metal blades (metal contacts) of the power converter plug 2 into an electric wall outlet 41 in a wall 4 to abut the hollow holder base 1 against the wall 4, and then connect the connector 211 of the power converter cable 21 to the power jack of the mobile electronic device 3 to be charged, and then rest the mobile electronic device 3 on the planar bearing surface 11 of the hollow holder base 1 to let the mobile electronic device 3 be stopped between the upwardly extended and gradually reduced retaining tips 121 of the stop members 12 and the wall 4. Thus, the mobile electronic device 3 is steadily held in the power converter plug mountable mobile electronic device holder and will not fall down or fall to the ground when it is being electrically charged.

Further, the hollow holder base 1 can be made in a rectangular, circular or polygonal shape, or any of a variety of other geometric shapes that fit the configuration of the power converter plug 2. When the mobile electronic device 3 is being electrically charged by city power supply from the electric wall outlet 41 in the wall 4 by means of the power converter cable 21, the mobile electronic device 3 can be steadily supported on the planar bearing surface 11 of the hollow holder base 1 and stopped between the upwardly extended and gradually reduced retaining tips 121 of the stop members 12 and the wall 4, avoiding contamination, water stains, insect biting, dirty or failure of the mobile electronic device 3 due to being positioned on the floor, or swinging or falling damage of the mobile electronic device 3 due to being left hanging in the air. Further, because the power converter plug mountable mobile electronic device is detachably mounted on the power converter plug 2, it can be repeatedly used. Alternatively, the power converter plug mountable mobile electronic device can be made out of a cheap material designed for a single use after which it is recycled or is disposed as solid waste.

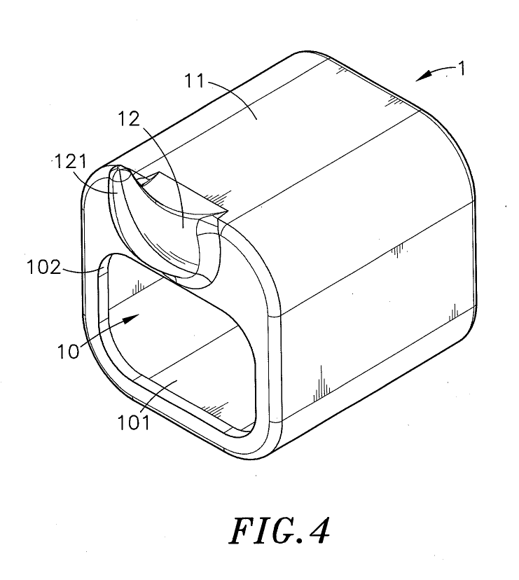

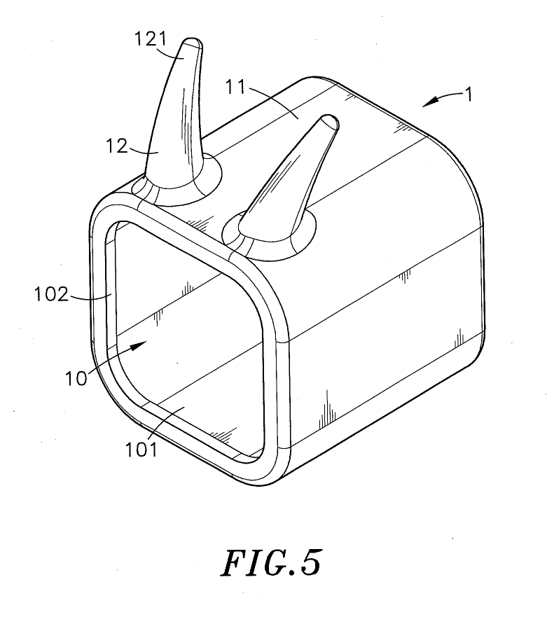

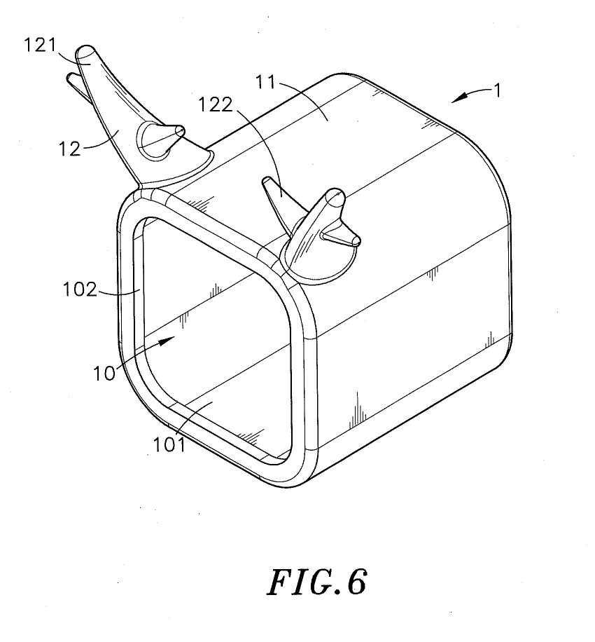

Referring to FIGS. 4-6, power converter plug mountable mobile electronic devices in accordance with a second embodiment, a third embodiment and a fourth embodiment of the present invention are shown. The power converter plug mountable mobile electronic device of the second embodiment is substantially similar to the aforesaid first embodiment with the exception that the power converter plug mountable mobile electronic device of the second embodiment comprises only one single stop member 12 that extends from the midpoint of the top side of the hollow holder base 1 (see FIG. 4). The power converter plug mountable mobile electronic device of the third embodiment is substantially similar to the aforesaid first embodiment with the exception that the two stop members 12 of the third embodiment extend upwardly from the front side of the planar bearing surface 11 of the hollow holder base 1 (see FIG. 5). The power converter plug mountable mobile electronic device of the fourth embodiment is substantially similar to the aforesaid third embodiment with the exception that the two stop members 12 of the fourth embodiment are respectively upwardly extended from opposite top corners between the two opposite sidewalls and bearing surface 11 of the hollow holder base 1, each comprising a plurality of conical protrusions 122 respectively extended from the periphery thereof at different elevations and at two opposite lateral sides relative to the upwardly extended and gradually reduced retaining tip 121 (see FIG. 6).

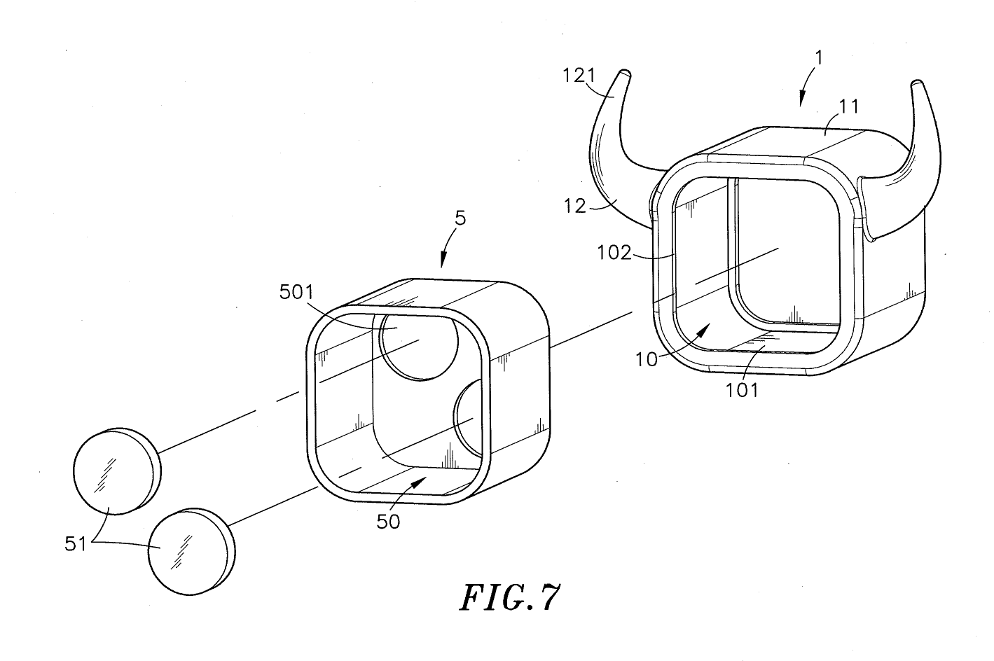

Referring to FIG. 7, a power converter plug mountable mobile electronic device in accordance with a fifth embodiment of the present invention is shown. This fifth embodiment is substantially similar to the aforesaid first embodiment with the exception of an added magnet holder shell 5 and at least one, for example, two magnets 51. The magnet holder shell 5 is a box member detachably mountable in the mating chamber 10 of the hollow holder base 1, defining therein an open chamber 50 and at least one, for example, two locating grooves 501 in a bottom side inside the open chamber 50. The magnets 51 are respectively fixedly fastened to the locating grooves 501 of the magnet holder shell 5. Molding technique, adhesive, or any, mounting technique can be employed to affix the magnets 51 to the locating grooves 501 of the magnet holder shell 5.

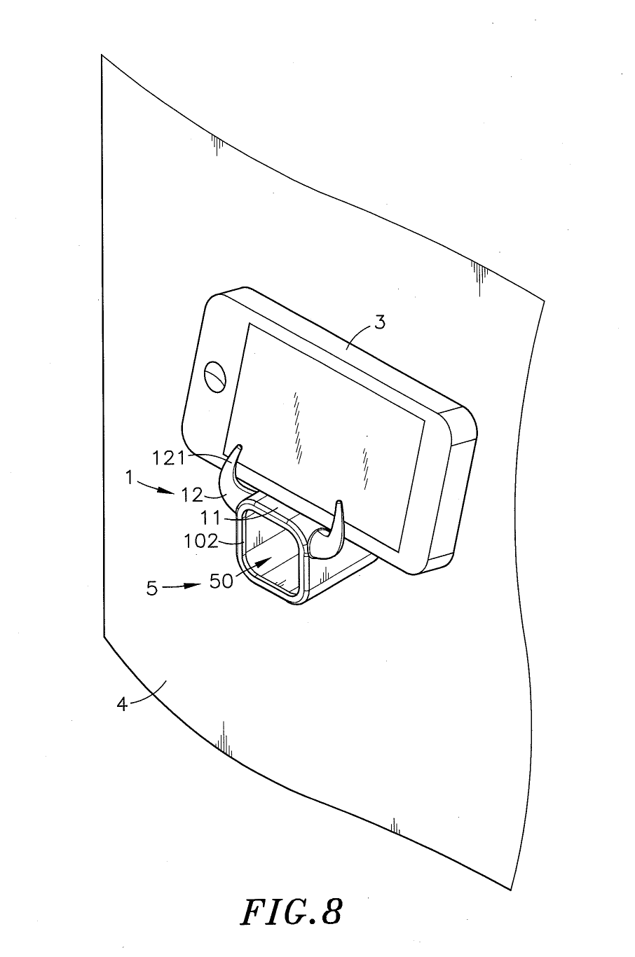

Referring to FIG. 8 and FIG. 7 again, if the power converter plug mountable mobile electronic device is not in use, i.e., after removal of the power converter plug 2 of the power converter cable 21 from the hollow holder base 1, the magnet holder shell 5 can be inserted into the mating chamber 10 of the hollow holder base 1 and secured with the hollow holder base 1 to a metal wall 4 by the magnets 51 by means of magnetic attraction to hold a mobile electronic device 3 on the planar bearing surface 11 of the hollow holder base 1, letting the mobile electronic device 3 be stopped between the upwardly extended and gradually reduced retaining tips 121 of the stop members 12 and the metal wall 4.

In conclusion, the invention provides a power converter plug mountable mobile electronic device holder, which comprises a hollow holder base 1 defining therein a mating chamber 10 and a planar bearing surface 11 at a top side thereof, and at least one stop member 12 suspending above the elevation of the planar bearing surface 11. The power converter plug mountable mobile electronic device holder is mountable on a power converter plug 2 of a power converter cable 21. The power converter plug mountable mobile electronic device holder can be mounted on the power converter plug 2 to support a mobile electronic device 3. When the power converter cable 21 is connected to an electric wall outlet 41 in a wall 4 to charge a mobile electronic device 3, the mobile electronic device 3 can be rested on the planar bearing surface 11 of the hollow holder base 1 and stopped between the upwardly extended and gradually reduced retaining tips 121 of the stop members 12 and the wall 4. Thus, the mobile electronic device 3 is steadily held in the power converter plug mountable mobile electronic device holder and will not fall down or fall to the ground when it is being electrically charged, avoiding contamination, water stains, insect biting, dirty or failure due to being positioned on the floor during charging, or vibrating or falling damage due to being left hanging in the air during charging.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A power converter plug mountable mobile electronic device holder mountable on a power converter plug of a power converter cable to hold a mobile electronic device being electrically charged by said power converter cable with city supply from an electric wall outlet in a wall, the power converter plug mountable mobile electronic device holder comprising a hollow holder base, said hollow holder base comprising a mating chamber, two openings respectively disposed at opposing front and rear sides thereof in communication between said mating chamber and the outside open space, a bearing surface located at a top side thereof, and at least one stop member suspending above the elevation of said bearing surface for supporting the mobile electronic device on said bearing surface.

2. The power converter plug mountable mobile electronic device holder as claimed in claim 1, wherein said hollow holder base further comprises a stop flange protruded from an inside wall thereof within each of said two openings for stopping a power converter plug of a power converter cable in said mating chamber.

3. The power converter plug mountable mobile electronic device holder as claimed in claim 1, wherein said bearing surface is a planar surface.

4. The power converter plug mountable mobile electronic device holder as claimed in claim 1, wherein the number of said at least one stop member is 2, and the two said stop members are respectively outwardly extended from two opposite lateral sides of said hollow holder base in a symmetrical manner.

5. The power converter plug mountable mobile electronic device holder as claimed in claim 1, wherein the number of said at least one stop member is 1, and the stop member is extended from a midpoint of a top side of said hollow holder base.

6. The power converter plug mountable mobile electronic device holder as claimed in claim 1, wherein the number of said at least one stop member is 2, and the two said stop members are respectively upwardly extended from a front side of said bearing surface.

7. The power converter plug mountable mobile electronic device holder as claimed in claim 1, wherein the number of said at least one stop member is 2, and the two said stop members are respectively upwardly extended from opposite top corners between two opposite sidewalls thereof and said bearing surface.

8. The power converter plug mountable mobile electronic device holder as claimed in claim 1, wherein each said stop member terminates in an upwardly extended and gradually reduced retaining tip.

9. The power converter plug mountable mobile electronic device holder as claimed in claim 1, wherein each said stop member comprises a plurality of conical protrusions respectively extended from the periphery thereof at two opposite lateral sides.

10. The power converter plug mountable mobile electronic device holder as claimed in claim 1, wherein said hollow holder base has a rectangular shape.

11. The power converter plug mountable mobile electronic device holder as claimed in claim 1, wherein said hollow holder base has a circular shape.

12. The power converter plug mountable mobile electronic device holder as claimed in claim 1, wherein said hollow holder base has a polygonal shape.
